(19) United States
(12) Patent Application Publication
(10) Pub. No.: US 2011/0134946 A1
(43) Pub. Date: Jun. 9, 2011

(54) LENGTHENING THE PATH OF A LASER BEAM IN A MONOLOTHIC SOLID STATE LASER APPARATUS

(75) Inventors: Yaniv VIDNE, Petah-Tikva (IL); Nissim ZAFRANI, Bnei Brak (IL); Shmuel GREENSTEIN, Rehovot (IL); Dov ABRAMOVICH, Tel-Aviv (IL); Yoav LAVON, Nes Ziona (IL)

(73) Assignee: ELBIT SYSTEMS ELECTRO-OPTICS ELOP LTD., Rehovot (IL)

(21) Appl. No.: 12/975,590

(22) Filed: Dec. 22, 2010

Related U.S. Application Data
(63) Continuation-in-part of application No. 11/817,578, filed on Aug. 31, 2007.

(30) Foreign Application Priority Data
Mar. 1, 2005 (IL) 167174

(51) Int. Cl. H01S 3/10; H01S 3/08; H01S 3/091

(52) U.S. Cl. 372/25; 372/92; 372/106; 372/70

(57) ABSTRACT

A solid state laser device is provided. The active element has a double slope portion defining a right angle between the slopes, wherein the pump light beam is directed into one of the slopes, and wherein an output coupler configured to output a laser beam from the active element is located on a portion of the active element, opposite of the double slope portion, the double slope portion is configured such that the laser beam travels at least twice along the long axis of the active element; and a second double slopes portion located at the edge opposite of the first double sloped portion, wherein the second double slopes portion is perpendicular to the first double slopes portion, and wherein the second double slopes portion is configured such that the laser beam travels back and forth along the long axis of the active element at least one more time.

### CROSS REFERENCE TO RELATED APPLICATIONS

This application is a Continuation-in-Part of U.S. patent application Ser. No. 11/817,578 which is a national stage of International Patent Application No. PCT/IL2006/000258 which claimed priority to foreign Israeli Patent Application No. 167,174 filed on Mar. 1, 2005, which are incorporated by reference.

### BACKGROUND

1. Technical Field

The present invention relates generally to laser devices, and more particularly, to solid state laser devices.

2. Discussion of the Related Art

Laser pumping is the act of energy transfer from an external source into the gain medium of a laser. The energy is absorbed in the medium, producing excited states in its atoms. When the number of particles in one excited state exceeds the number of particles in the ground state or a less-excited state, population inversion is achieved. In this condition, the mechanism of stimulated emission can take place and the medium can act as a laser or an optical amplifier. The pump power must be higher than the lasing threshold of the laser.

### BRIEF SUMMARY

One aspect of the invention provides a solid state laser device exhibiting a lengthened optical path of the laser beam within the active element. The device includes an active element that has a double slope portion defining a right angle between the slopes, wherein the pump light beam is directed into one of the slopes, and wherein an output coupler configured to output a laser beam from the active element is located on a portion of the active element, opposite of the double slope portion, the double slope portion is configured such that the laser beam travels at least twice along the long axis of the active element. Additionally, the device further includes a second double slopes portion located at the edge opposite of the first double sloped portion, wherein the second double slopes portion is perpendicular to the first double slopes portion, and wherein the second double slopes portion is configured such that the laser beam travels back and forth along the long axis of the active element at least one more time on a parallel plane.

### BRIEF DESCRIPTION OF THE DRAWINGS

For a better understanding of embodiments of the invention and to show how the same may be carried into effect, reference will now be made, purely by way of example, to the accompanying drawings in which like numerals designate corresponding elements or sections throughout.

In the accompanying drawings:

FIG. 1 is a perspective view illustrating a laser device according to some embodiments of the present invention;

FIG. 2 is perspective view illustrating a laser device according to some embodiments of the present invention;

FIG. 3 is a perspective view illustrating a laser device according to some embodiments of the present invention;

FIG. 4 is a schematic diagram illustrating a laser device according to some embodiments of the present invention;

FIG. 5 is a graph diagram illustrating absorption lines of different light pumping elements according to some embodiments of the present invention;

FIG. 6 is a flowchart diagram illustrating a method of laser pumping according to some embodiments of the present invention;

The drawings together with the following detailed description make apparent to those skilled in the art how the invention may be embodied in practice.

### DETAILED DESCRIPTION

With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

Before explaining at least one embodiment of the invention in detail, it is to be understood that the invention is not limited in its application to the details of construction and the arrangement of the components set forth in the following description or illustrated in the drawings. The invention is applicable to other embodiments or of being practiced or carried out in various ways. Also, it is to be understood that the phraseology and terminology employed herein is for the purpose of description and should not be regarded as limiting.

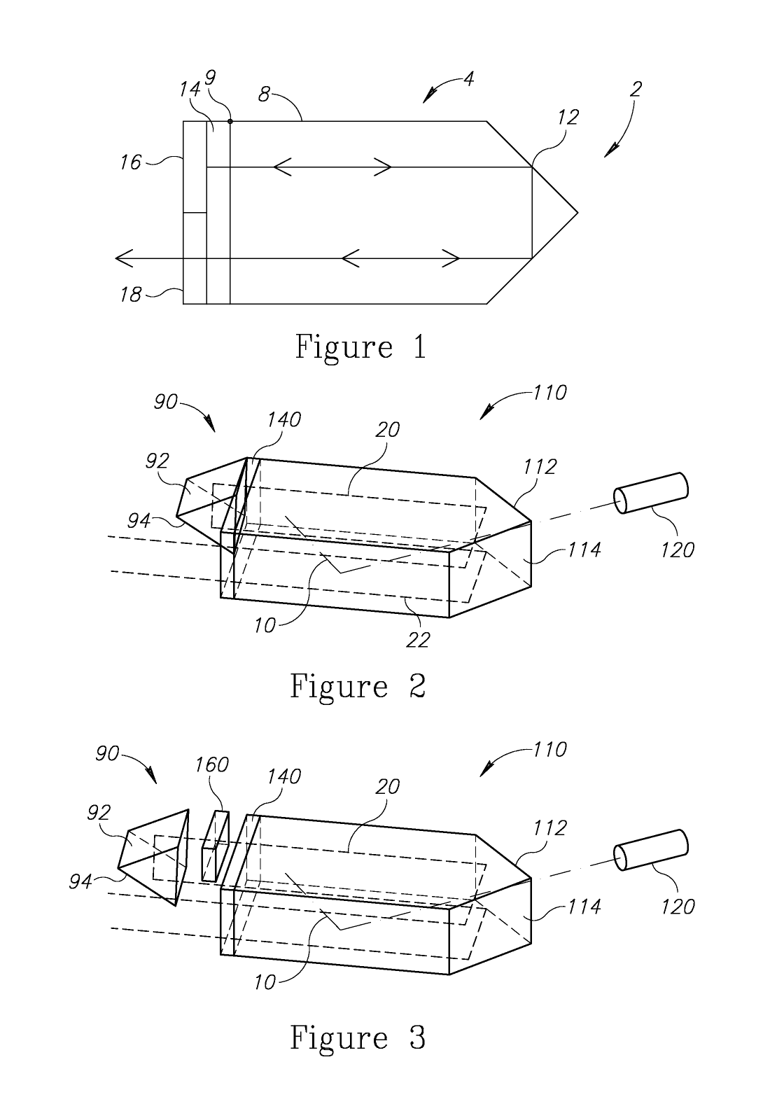

FIG. 1 is a schematic diagram illustrating a laser device according to some embodiments of the present invention. Solid-state laser apparatus 2, including a solid-state active element 4 having major surfaces and first and second edges 9 and 12 oppositely disposed to each other, the first edge 9 being flat and the second edge 12 being constituted by first and second perpendicularly disposed surfaces 12 or having first and second perpendicularly disposed surfaces 12 located adjacent to the second edge, a back reflector 16 and an output coupler 18 located at, or adjacent to, the first edge 9 light induced in the cavity forms two parallel beams passing therethrough, by means of a first beam which is reflected by the back reflector 16 towards a first of the perpendicularly disposed surfaces and being folded to pass on to the second surface, to be further folded and to proceed towards the first edge 9. A saturable absorber 14 may be attached to the first edge 9.

FIG. 2 is a perspective view illustrating a laser device according to some embodiments of the present invention comprising an active element 110 exhibiting two perpendicular slopes 112 and 114 located at one end of the active element, and a pumping element pumping via slope 112 (although side pumping is also possible). In addition, the laser device further includes a folding prism 90 having two perpendicular slopes 92, 94 located opposite the double slopes 112 and 114, wherein folding prism 90 is perpendicular to the double slopes portion, and wherein the folding prism 90 is configured such that the laser beam travels at least four times along the long axis of the active element as shown in laser beams 20 and 22 that are on parallel planes. The second double slopes portion 90 is advantageous in achieving an even more efficiency in the lasing and light amplification.

FIG. 3 is a perspective view illustrating a laser device according to some embodiments of the present invention. In addition to folding prism 90 as explained above, the device further includes a polarizer 160 located between folding prism 90 and active element 110 and configured to polarize the laser beam 20 when passing to a lower level (beams 22). This contributes to the stability and the overall quality of the laser beam produced.

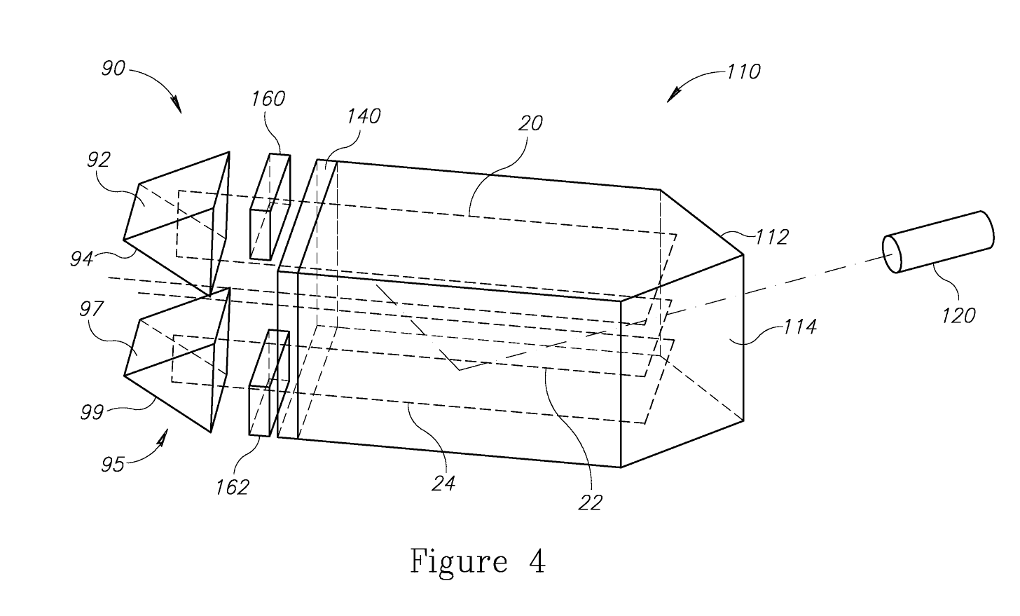

FIG. 4 is a perspective view illustrating a laser device according to some embodiments of the present invention including a folding prism 90 and a polarizer 160 as explained above and further another folding prism 95 (slopes 97 and 99) and another polarizer 162 positioned such that another level of laser beams 24 are produced so that even more energy is produced within the laser beam. Similarly—more levels of laser beams may be produces by adding more folding prisms with or without polarizing elements accordingly.

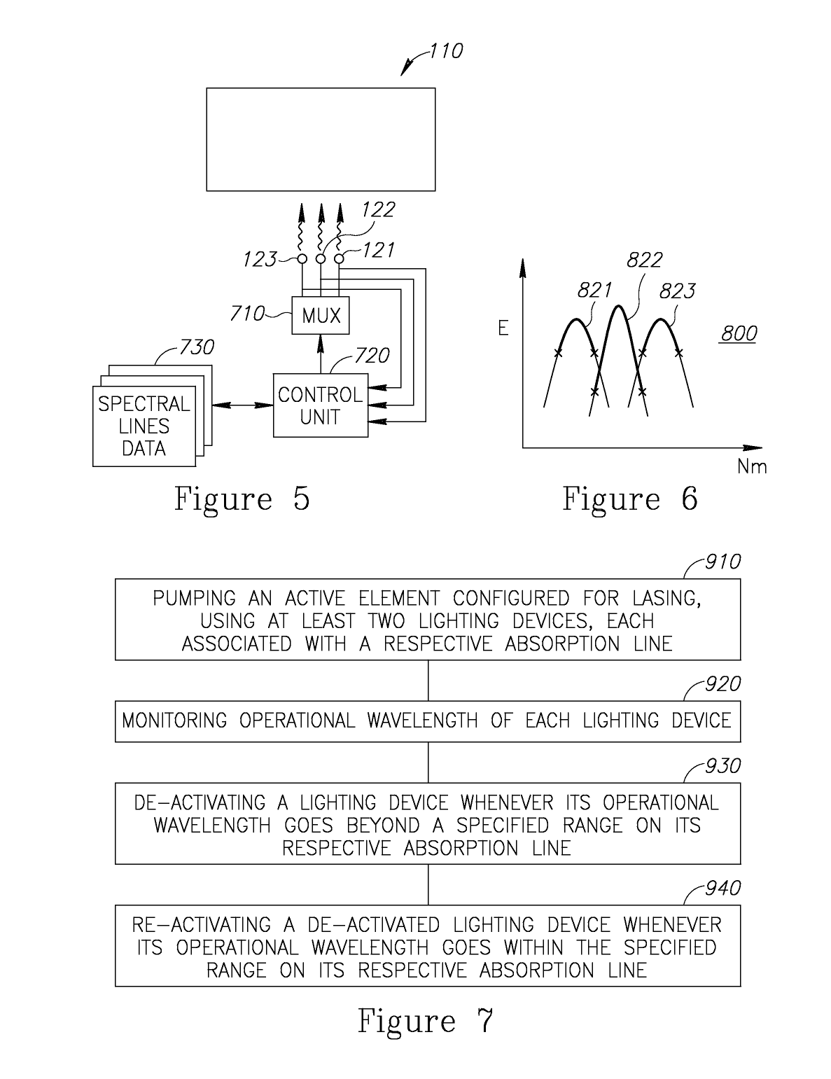

FIG. 5 is a schematic diagram illustrating a laser device according to some embodiments of the present invention. Solid state laser device may include: an active element 110 configured as a gain medium for lasing; two or more light pumping elements 121-123 optically coupled to active element 110. A control unit 720 is in operative association with light pumping elements 121-123 via multiplexer 710 and is further in operative associating with a temperature dependence lookup table 730. FIG. 6 is a graph diagram illustrating emission lines of light pumping elements 121-123. As shown, emission lines 821-823 have each a specified range of efficiency (marked in bold lines bordered by x).

In operation, each one of light pumping elements 121-123 is associated with a specified absorption range as shown and a control module in operative association with the light pumping elements, wherein the control unit is configured to: monitor operational wavelength of each light pumping element; de-activate a light pumping element whenever its operational wavelength goes beyond a specified range on its respective absorption line; and re-activate a de-activated light pumping element whenever its operational wavelength goes within the specified range on its respective absorption line.

Consistent with one embodiment of the invention multiplexer 710 being in operative association with control unit 720 is configured to de-activate and re-activate the light pumping element responsive of control unit 720. In addition, control unit 720 is further configured to compare actual operational wavelength of each light pumping element to spectral lines data 730 for determining efficiency range of the light pumping elements upon which the deactivating and re-activating is based.

Advantageously, multiplexing operation of the pump lighting elements overcomes the need to stabilize the operation of the pump lighting elements (usually diodes) which have a tendency to have a varying operation wavelength dependent upon temperature. The aforementioned feature thus improves the temperature independence (and hence the temperature operational range) of a solid state laser device. Consistent with yet another embodiment of the invention active element 110 combines the multiplexing feature and the multi layers (planes) of laser beams achieved due to the folding prisms (and polarizing elements) discussed above.

Consistent with yet another embodiment of the invention active element 110 is associated with a specified geometric shape and specified optical characteristics, wherein the light pumping elements are configured to generate a pump light beam (not shown here) directed at a specified angle into the active element, and wherein at least one of: the specified angle, the specified geometric shape, and the specified optical characteristics are selected such that the pump light beam is reflected one or more times within the active element resulting in an extension of an absorption path of the pump light beam within the active element.

FIG. 7 is a flowchart diagram illustrating a method of laser pumping according to some embodiments of the present invention. The method may include the following steps: pumping an active element configured for lasing, using two or more light pumping elements, each associated with a respective absorption line 910. The method goes on to monitoring operational wavelength of each light pumping element 920. Then, the method goes on to de-activating a light pumping element whenever its operational wavelength goes beyond a specified range on its respective absorption line 930 and finally to re-activating a de-activated light pumping element whenever its operational wavelength goes within the specified range on its respective absorption line. Naturally, the deactivating and re-activating may be repeated on an ad hoc basis based on the operational wavelength of each pump lighting element.

Any publications, including patents, patent applications and articles, referenced or mentioned in this specification are herein incorporated in their entirety into the specification, to the same extent as if each individual publication was specifically and individually indicated to be incorporated herein. In addition, citation or identification of any reference in the description of some embodiments of the invention shall not be construed as an admission that such reference is available as prior art to the present invention.

While the invention has been described with respect to a limited number of embodiments, these should not be construed as limitations on the scope of the invention, but rather as exemplifications of some of the preferred embodiments. Other possible variations, modifications, and applications are also within the scope of the invention. Accordingly, the scope of the invention should not be limited by what has thus far been described, but by the appended claims and their legal equivalents.

What is claimed is:

1. A solid state laser device comprising:
an active element having a double slope portion defining a right angle between the slopes, wherein the pump light beam is directed into one of the slopes, and wherein an output coupler configured to output a laser beam from the active element is located on a portion of the active element, opposite of the double slope portion, the double slope portion is configured such that the laser beam travels at least twice along the long axis of the active element; and
a second double slopes portion located at the edge opposite of the first double sloped portion, wherein the second double slopes portion is perpendicular to the first double slopes portion, and wherein the second double slopes portion is configured such that the laser beam travels back and forth along the long axis of the active element at least one more time.

2. The laser device according to claim 1, further comprising a polarizer coupled to the second double slopes portion and overlapping one of the slopes.

3. The laser device according to claim 1, further comprising one or more additional double slopes portions located at the edge opposite of the first double sloped portion, wherein each one of the additional double slopes portions is perpendicular to the first double slopes portion, and located alternately at the edge opposite of the first double sloped portion such that each additional double slopes portion is configured such that the laser beam travels back and forth along the long axis of the active element at least one more time.

4. The laser device according to claim 3, further comprising a polarizer coupled to each one of the second double slopes portion and overlapping one of the slopes.

5. The laser device according to claim 1, further comprising:
two or more light pumping elements optically coupled to the active element, wherein each light pumping element is associated with a specified absorption line; and
a control module in operative association with the light pumping elements,
wherein the control unit is configured to:
deduce momentary operational wavelength of each light pumping element;
de-activate a light pumping element whenever its operational wavelength goes beyond a specified range on its respective absorption line; and
re-activate a de-activated light pumping element whenever its operational wavelength goes within the specified range on its respective absorption line.

6. The laser device according to claim 5, further comprising a multiplexer in operative association with the control unit and the light pumping elements, and wherein the control unit is configured to de-activate and re-activate the light pumping element via the a multiplexer.

7. The laser device according to claim 6, wherein the control unit is further configured to compare actual operational wavelength of each light pumping element to spectral lines data for determining efficiency range of the light pumping elements upon which the deactivating and re-activating is based.
